(19) United States
(12) Patent Application Publication
(10) Pub. No.: US 2026/0220471 A1
(43) Pub. Date: Jul. 30, 2026

(54) MOBILE DEVICES WITH ADAPTIVE GEN-AI TECHNOLOGY

(71) Applicant: AT&T Intellectual Property I, L.P., Atlanta, GA (US)

(72) Inventors: Yupeng Jia, South Pasadena, CA (US); Hongyan Lei, Plano, TX (US)

(73) Assignee: AT&T Intellectual Property I, L.P., Atlanta, GA (US)

(21) Appl. No.: 19/037,526

(22) Filed: Jan. 27, 2025

(51) Int. Cl. G06N 3/0895

(52) U.S. Cl. CPC G06N 3/0895

(57) ABSTRACT

Aspects of the subject disclosure may include, for example, mobile devices that receive sensor data, train a large language model (LLM) to identify patterns, and determine whether to store information in short-term or long-term memory. The LLM utilizes this stored information to respond to user queries, facilitating personalized interactions and decision-making. Other embodiments are disclosed.

### BACKGROUND

In recent years, the capabilities and expectations surrounding mobile devices have significantly evolved. As technology advances, users increasingly demand more from their mobile devices, seeking enhanced functionality, improved performance, and seamless integration into their daily lives. Mobile devices have transitioned from simple communication tools to complex systems capable of handling a wide array of tasks, from entertainment and social interaction to productivity and information management.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIGS. 2B and 2C depict illustrative embodiments of methods in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for adaptive generative artificial intelligence mobile devices capable of leveraging Large Language Models (LLMs) for personalized interactions, memory management, intention recognition, and enhanced decision-making. Other embodiments are described in the subject disclosure.

Various embodiments described herein provide a generative artificial intelligence (Gen-AI) mobile phone that offers personalized interactions and decision-making by leveraging short-term and long-term memory, adaptive storage based on user behavior, multi-modal sensing, personalized LLMs, intention recognition, and enhanced AI support from the cloud, all while efficiently managing emergency scenarios.

In today's fast-paced and interconnected world, users demand a highly personalized and efficient mobile experience that seamlessly adapts to their unique needs and behaviors. Current mobile devices often fall short in providing tailored interactions, efficient memory management, and adaptive decision-making, leading to suboptimal user experiences. The various embodiments described herein provide on-device AI models and multi-modal data integration that provide the ability of mobile devices to understand user intentions and respond effectively in emergency scenarios.

The various embodiments described herein leverage advanced human-phone interaction capabilities, utilizing personalized user profiles to perform tasks tailored to individual needs. By implementing sophisticated memory management strategies that distinguish between short-term and long-term storage, the various embodiments provide efficient data usage pertinent to gen-AI use cases. Adaptive storage decisions, informed by continuous learning of user behaviors, further improve data management.

The various embodiments provide personalized decision-making processes and adaptive AI service levels, ensuring that even less capable on-device AI models can provide a satisfactory user experience. Enhanced AI support from the cloud edge augments on-device intelligence, while multi-modal decision-making integrates data from various sensors and 6G sensing to enhance input quality and dimensionality.

As described herein, personalized LLMs on individual mobile phones enable cross-functional learning and intention recognition, improving interaction and collaboration with other devices. The various embodiments are also equipped to handle emergency scenarios efficiently, ensuring user safety and responsiveness.

Accordingly, the various embodiments described herein provides for a more personalized, adaptive, and intelligent mobile experience, enhancing user satisfaction and device performance.

One or more aspects of the subject disclosure include a device, comprising a processing system including a processor and a memory that stores executable instructions that, when executed by the processing system, facilitate performance of operations. The operations may include receiving sensor data from a plurality of sensors associated with the device; training a large language model (LLM) using the sensor data to determine at least one pattern; determining whether to store information related to the at least one pattern in short-term memory or long-term memory; and utilizing, by the LLM, the information stored in the short-term memory and long-term memory as context when responding to user queries.

Additional aspects of the subject disclosure may include the plurality of sensors comprising at least one of a motion sensor, a location sensor, an orientation sensor, or an audio sensor; wherein the training of the LLM is performed continuously as new sensor data is received; determining whether to store the information in the short-term memory or the long-term memory based on a frequency of access; configuring the short-term memory to store information for a predetermined period before being overwritten or transferred to long-term memory; determining whether to store the information in the short-term memory or the long-term memory based on user behavior, patterns of usage frequency, or relevance to ongoing tasks.

One or more aspects of the subject disclosure include a non-transitory machine-readable medium, comprising executable instructions that, when executed by a processing system including a processor, facilitate performance of operations. The operations may include detecting, by a large language model (LLM) in a first mobile device, an intention of a second mobile device by analyzing communication signals received from the second mobile device; facilitating collaboration between the first mobile device and the second mobile device based on the detecting the intention; determining whether to store information related to the collaboration in short-term memory or long-term memory; and utilizing the information stored in the short-term memory and the long-term memory to enhance future interactions and collaborations.

Additional aspects of the subject disclosure may include training the LLM using the information related to the collaboration; performing unsupervised training of the LLM to determine at least one pattern related to the collaboration; utilizing the information stored in the short-term memory and the long-term memory to determine whether to facilitate additional collaborations between mobile devices; and detecting the intention by determining whether the second mobile device is requesting emergency communications.

One or more aspects of the subject disclosure include a method, comprising receiving, by a processing system including a processor, sensor data from a plurality of sensors; training, by the processing system, a large language model (LLM) in a mobile device using the sensor data to determine at least one pattern; determining, by the processing system, whether to store information related to the at least one pattern in short-term memory or long-term memory based on a type of pattern determined; and utilizing, by the processing system, the information stored in the short-term memory and long-term memory as context when the LLM is responding to user queries.

Additional aspects of the subject disclosure may include the plurality of sensors comprising at least one of a motion sensor, a location sensor, an orientation sensor, or an audio sensor; wherein the training of the LLM is performed continuously as new sensor data is received; determining whether to store the information in the short-term memory or the long-term memory based on a frequency of access; configuring the short-term memory to store information for a predetermined period before being overwritten or transferred to long-term memory.

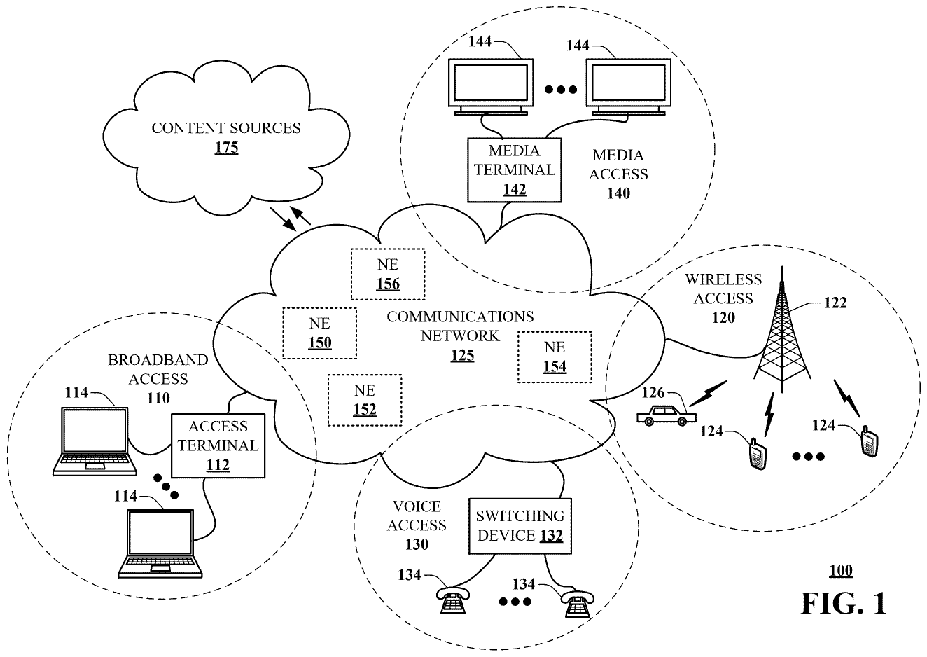

Referring now to FIG. 1, a block diagram is shown illustrating an example, non-limiting embodiment of a system 100 in accordance with various aspects described herein. For example, system 100 can facilitate, in whole or in part, the operation of mobile devices with LLMs capable of personalized interactions, adaptive memory management, and intention recognition as described herein. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In some embodiments, the base station or access point 122 can be enhanced by incorporating a large language model (LLM). The inclusion of an LLM within the base station 122 allows for advanced processing capabilities directly at the network edge, facilitating more efficient and intelligent communication with mobile devices 124. The LLM can analyze and interpret data received from these devices, enabling real-time decision-making and personalized interactions.

By leveraging the LLM, the base station 122 can perform tasks such as optimizing network traffic, predicting user needs, and providing contextually relevant services. This integration enhances the overall user experience by reducing latency and improving the responsiveness of the network. Additionally, the LLM can assist in managing network resources more effectively, ensuring seamless connectivity and maintaining high-quality service levels for users.

Furthermore, the LLM-equipped base station 122 can collaborate with other network elements, such as mobile devices 124, the communications network 125, and content sources 175, to deliver enriched media content and support complex applications, such as immersive 3D environments or real-time language translation. This capability positions the base station 122 as a critical component in the delivery of next-generation mobile services, leveraging AI to meet the growing demands of modern users.

In some embodiments, mobile devices 124 may be equipped with large language models (LLMs) to enhance their functionality and user experience. The integration of LLMs into mobile devices 124 allows these devices to perform advanced data processing and provide personalized interactions directly on the device. For example, the LLMs in mobile devices 124 can be used to analyze sensor data, recognize user patterns, and make contextually relevant decisions. This capability enables the devices to offer personalized services, such as tailored recommendations, predictive text input, and adaptive user interfaces. By processing data locally, the LLMs can reduce latency and improve the responsiveness of the device, providing a seamless user experience.

Additionally, the LLMs in mobile devices 124 may facilitate intention recognition, allowing mobile devices 124 to understand and anticipate user needs. This feature can be used to enhance device-to-device collaboration, where the LLMs analyze communication signals from other devices to determine intentions and facilitate interactions. The LLMs may also manage memory efficiently by deciding whether to store information in short-term or long-term memory based on user behavior and relevance to ongoing tasks.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

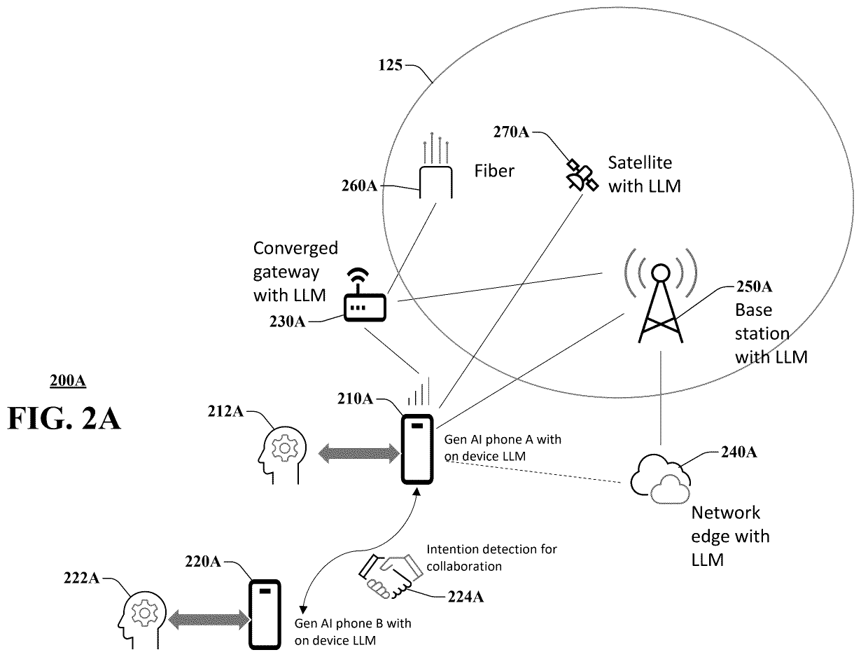

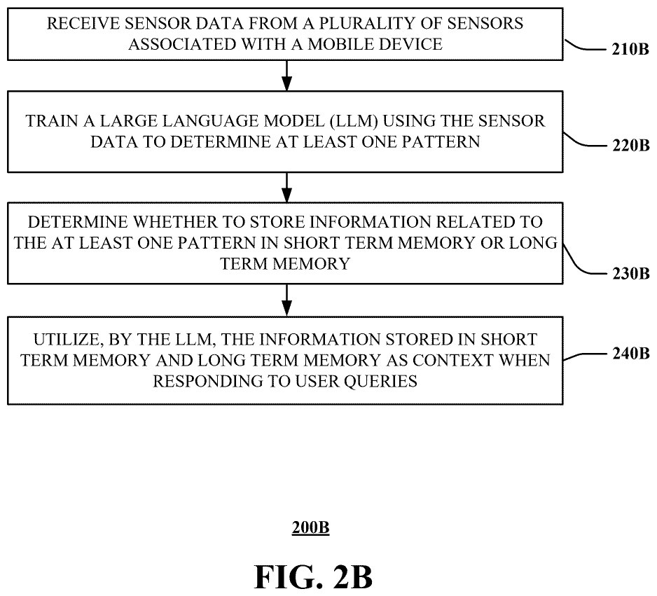

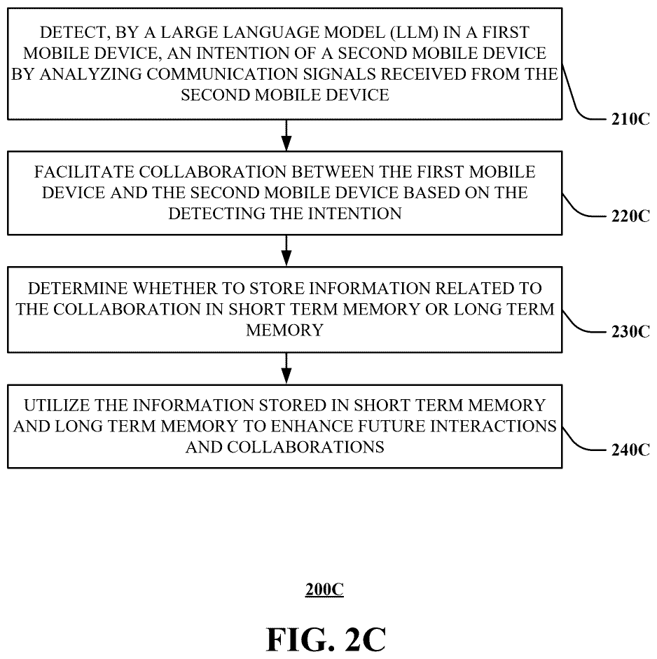

FIG. 2A is a block diagram illustrating an example, non-limiting embodiment of a system functioning within the communication network of FIG. 1 in accordance with various aspects described herein. The system depicted in FIG. 2A illustrates a communication network 125 that integrates various components to facilitate advanced mobile interactions using generative artificial intelligence (Gen-AI) technology. This system is designed to enhance user experience through personalized interactions and decision-making capabilities.

The Gen AI phone A with on-device LLM 210A and Gen AI phone B 220A are mobile devices equipped with large language models (LLMs) that process sensor data to provide personalized user interactions. The LLM is trained using data from various sensors, enabling the mobile device to recognize patterns and make decisions based on user behavior. The mobile device can store information in short-term or long-term memory, optimizing data management and enhancing the user experience by providing contextually relevant responses to user queries.

The Gen AI phone A 210A may also include the capability of detecting intentions from other devices. This feature facilitates collaboration between devices by analyzing communication signals and determining the appropriate response. The mobile device can decide whether to store collaboration-related information in short-term or long-term memory, thereby improving future interactions and collaborations.

In some embodiments, each mobile device features an individualized LLM that supports cross-functional learning. This capability allows the LLM to adapt to user-specific needs and preferences, continuously improving its performance across various tasks and applications.

The intention detection for collaboration 224A represents Gen AI phone A 210A detecting a request from the Gen AI phone B 220A for interaction and/or collaboration, and recognizing the intention of the Gen AI phone B 220A. This capability is achieved through the analysis of communication signals, allowing the devices to facilitate seamless collaboration. The system can dynamically adjust responses based on the context of the interaction, enhancing the overall user experience.

The network edge with LLM 240A provides additional computational support to the Gen AI phones 210A and 220A. In some embodiments, this component is capable of offloading intensive data processing tasks from the mobile devices to the network edge, thereby optimizing performance and resource utilization. The network edge can process complex tasks, such as immersive 3D environments, and return processed data to the devices, ensuring efficient operation even when on-device capabilities are limited.

The base station with LLM 250A serves as a communication hub within the network, facilitating data exchange between the Gen AI phones 210A and 220A and other network components. In some embodiments, the base station is equipped with an LLM to support advanced communication and processing tasks, enhancing the network's ability to manage data traffic and provide personalized services to users.

The converged gateway with LLM 230A acts as an interface between the communication network 125 and external networks, enabling seamless data flow and connectivity. In some embodiments, this gateway is equipped with an LLM to manage data processing and routing, ensuring efficient communication between the Gen AI phones 210A and 220A and other network elements. The gateway supports high-compute capability connectivity, allowing the system to engage with other high-performance endpoints, such as satellites or network edges.

The fiber 260A represents the physical infrastructure that connects the various components within the communication network 125. This infrastructure provides high-speed data transmission capabilities, ensuring reliable and efficient communication between the Gen AI phones 210A and 220A, the network edge 240A, the base station 250A, and the converged gateway 230A. The fiber infrastructure supports the system's ability to deliver personalized and adaptive services to users.

The satellite with LLM 270A, as depicted in FIG. 2A, represents an advanced component within the communication network 125 that leverages a large language model (LLM) to enhance satellite communication capabilities. This integration allows the satellite to perform complex data processing tasks, enabling more intelligent and efficient communication with other network components, such as mobile devices, base stations, and network edges.

The LLM within the satellite 270A can analyze and interpret data transmitted to and from the satellite, facilitating real-time decision-making and personalized interactions. This capability is particularly beneficial in scenarios where terrestrial network infrastructure is limited or unavailable, as the satellite can provide seamless connectivity and support for remote or mobile users.

By incorporating an LLM, the satellite 270A can optimize data routing, manage bandwidth allocation, and predict user needs, thereby improving the overall efficiency and responsiveness of the network. Additionally, the satellite can collaborate with other LLM-equipped components, such as the base station 250A and network edge 240A, to deliver enriched media content and support complex applications, such as real-time language translation or immersive 3D environments.

In some embodiments, the LLM within the mobile device can enhance user convenience by utilizing both short-term and long-term memory to manage routine tasks. In these embodiments, recurring activities and/or patterns may be stored in long-term memory, and more immediately relevant information may be stored in short-term memory. As an example, the LLM may aid a user such as user 212A during an activity such as shopping. In the context of FIG. 2A, the Gen AI phone A 210A, equipped with an on-device large language model (LLM), may interact with user 212A to enhance their shopping experience through a personalized shopping list reminder feature.

In this example, the information “shopping for vegetables” may be stored in long-term memory as a recurring activity or pattern recognized by the LLM. This long-term memory storage allows the phone to understand that user 212A frequently shops for vegetables, enabling it to anticipate this need and prepare relevant information in advance. On the other hand, a detailed list of vegetables, such as “carrots, broccoli, and spinach,” may be stored in short-term memory. This list represents the specific items needed for a particular shopping trip and can be quickly accessed and modified as user 212A navigates the store. By maintaining the general activity of “shopping for vegetables” in long-term memory and the specific list in short-term memory, the LLM can efficiently manage data, providing user 212A with timely and relevant assistance during their shopping experience.

In some embodiments, the large language model (LLM) utilizes sensor inputs to recognize patterns in user behavior and to populate the long-term memory. For instance, when user 212A frequently visits grocery stores, the phone's location sensor detects these visits, and the motion sensor may register the user's movement patterns within the store. Over time, the LLM analyzes this data and identifies a recurring pattern of shopping for vegetables. This pattern recognition is facilitated by the LLM's ability to correlate the sensor data with user interactions, such as queries about vegetables or updates to a shopping list.

Once the LLM identifies the pattern of shopping for vegetables, it stores this information in long-term memory. This storage allows the phone to anticipate user 212A's needs in future shopping trips, providing relevant reminders or suggestions without requiring repeated input from the user. By maintaining this pattern in long-term memory, the LLM ensures that the phone can offer personalized assistance, enhancing the overall user experience by adapting to user habits and preferences.

Continuing with the example, as user 212A approaches a store, the Gen AI phone A 210A utilizes its LLM to access short-term memory, retrieving a previously created shopping list. This immediate access to the shopping list provides user 212A with convenient assistance, eliminating the need for manual searching. The LLM in phone 210A may be continuously trained using sensor data and user interactions, allowing it to recognize patterns in user behavior, such as frequent visits to the same store.

When user 212A queries the phone for specific items or updates to the shopping list, the LLM processes these requests by leveraging both short-term and long-term memory. Short-term memory is used to store temporary data, such as the current shopping list, which can be quickly accessed and modified during the shopping trip. If user 212A frequently visits the same store, the LLM learns this pattern and stores or updates the shopping list in long-term memory. This enables the phone to automatically suggest the list upon user 212A's arrival at the store in future visits, demonstrating the system's ability to adapt to user habits over time.

The LLM's ability to respond to user 212A's queries is enhanced by its training, which incorporates user preferences and historical data. This allows the Gen AI phone A 210A to provide contextually relevant responses, such as suggesting alternative items or notifying user 212A of special offers related to their shopping list. Through these interactions, the Gen AI phone A 210A not only streamlines the shopping experience but also exemplifies the personalized and adaptive capabilities of the LLM in enhancing user satisfaction.

A travel option suggestion is another example of the LLM within the mobile device enhancing user convenience by utilizing both short-term and long-term memory to manage routine tasks. In this example, the mobile device may act as a personal travel assistant by leveraging the LLM to analyze user preferences and schedules stored in both short-term and long-term memory. When user 212A plans a trip, the LLM accesses long-term memory to retrieve stored preferences, such as preferred airlines, routes, and travel times. This information has been accumulated over time through user interactions and queries related to past travel experiences.

As user 212A interacts with phone 210A, the LLM processes real-time data, such as current flight availability and pricing, using short-term memory. This allows the phone to provide immediate, contextually relevant travel options tailored to user 212A's preferences and schedule.

The LLM in phone 210A is continuously trained using sensor data and user interactions, enabling it to refine its understanding of user 212A's travel habits and preferences. When user 212A queries the phone for travel suggestions, the LLM responds by combining insights from both short-term and long-term memory, offering personalized recommendations that align with the user's needs.

Through these interactions, the Gen AI phone A 210A not only streamlines the travel planning process but also exemplifies the adaptive capabilities of the LLM, enhancing user satisfaction by providing a seamless and personalized travel experience by providing tailored recommendations that align with their preferences and schedule.

In some embodiments, a mobile device equipped with a large language model (LLM) may offload processing tasks to other high-compute-capability devices or endpoints, such as the cloud edge, gateways, base stations, or satellites, to leverage increased processing power. This offloading process may be useful in scenarios where the on-board LLM requires more computational resources than are available on the mobile device itself. In these embodiments, the LLM may assess the device's current capabilities and the complexity of the task to determine which data and processes are suitable for offloading.

In some embodiments, short-term memory within the mobile device may be utilized to manage immediate processing tasks, ensuring that essential operations continue without interruption. Meanwhile, long-term memory may store information about past offloading decisions and their outcomes. This historical data allows the system to refine its offloading strategy over time, improving efficiency and effectiveness.

By distributing the processing load between the mobile device and external high-compute-capability endpoints, the system provides efficient resource utilization. This approach maintains a high level of performance, even when the on-device LLM is less capable, by dynamically balancing the computational demands across available resources.

In some embodiments, the large language model (LLM) within a mobile device is capable of collaborating with other nearby mobile devices by recognizing the intentions of those devices'requests for collaboration. This capability allows the mobile device to dynamically decide whether to engage in collaboration based on the context and nature of the request.

For example, a first mobile device may receive a collaboration request from a second mobile device and decide to allow the requested collaboration. Consider a scenario where a first mobile device with an LLM detects a request from a second mobile device to share location data for a group navigation activity. The LLM in the first device analyzes the communication signals and recognizes the intention as a collaborative effort to coordinate a group outing. Given the context and the non-sensitive nature of the data involved, the first mobile device decides to collaborate. It shares the necessary location data and receives updates from the second device, facilitating a seamless group navigation experience. The information related to this collaboration may be stored in short-term memory for immediate use and may be transferred to long-term memory if similar collaborations are frequent, enhancing future interactions.

Also for example, a first mobile device may receive a collaboration request from a second mobile device and decide to not allow the requested collaboration. Consider a scenario where the first mobile device with an LLM receives a request from a second mobile device to access personal contact information for a marketing campaign. The LLM analyzes the request and recognizes the intention as a potential privacy risk. Given the sensitive nature of the data and the lack of user consent, the first mobile device decides not to collaborate. It declines the request, ensuring the user's privacy is maintained. The decision and context are stored in long-term memory, allowing the LLM to refine its decision-making process and improve its ability to protect user data in future interactions.

In still further embodiments, the system can utilize its LLM to quickly assess and respond to potential threats. For example, if a vehicle collision is imminent, the device can retrieve real-time sensor data, such as speed and proximity to other vehicles, and use this information to trigger an immediate response, such as alerting the driver or activating safety features. Long-term memory may store historical data on past emergency scenarios, allowing the LLM to learn from these events and improve its response strategies over time. Additionally, health-related sensor data can be monitored to detect emergencies, such as abnormal heart rates, prompting the device to call emergency services if necessary. This proactive approach enhances user safety by providing timely and effective responses to critical situations.

FIGS. 2B and 2C depict illustrative embodiments of methods in accordance with various aspects described herein. FIG. 2B illustrates a method 200B that may be performed by components such as the Gen AI phone A 210A, which includes a large language model (LLM) and various sensors.

At block 210B, the method involves receiving sensor data from a plurality of sensors associated with a mobile device. In some embodiments, this block involves collecting data from sensors like motion, location, and orientation sensors. For example, the mobile device may gather data on user movements and environmental conditions to inform subsequent processing.

At block 220B, the method includes training a large language model (LLM) using the sensor data to determine at least one pattern. The LLM may be trained using either supervised or unsupervised methods. In supervised training, the LLM is provided with labeled data, allowing it to learn specific patterns and associations based on predefined examples. For example, the LLM might be trained to recognize shopping patterns by being fed data labeled with specific shopping activities. In unsupervised training, the LLM analyzes the sensor data without predefined labels, identifying patterns and correlations autonomously. This approach allows the LLM to discover new patterns, such as frequent visits to a particular location, without prior knowledge.

At block 230B, the method involves determining whether to store information related to the at least one pattern in short-term memory or long-term memory. Short-term memory is characterized by its ability to store information temporarily, making it ideal for handling immediate tasks and transient data. For example, short-term memory might store a shopping list for a single trip or details of a one-time event. In contrast, long-term memory is designed for retaining information over extended periods, allowing the LLM to store recurring patterns or frequently accessed data. For instance, long-term memory might hold user preferences for travel routes or regularly purchased grocery items. The decision between short-term and long-term memory storage is influenced by factors such as the frequency of access, relevance to ongoing tasks, and user behavior, ensuring efficient memory management.

At block 240B, the method includes utilizing, by the LLM, the information stored in short-term memory and long-term memory as context when responding to user queries. In some embodiments, this involves the LLM leveraging stored patterns to provide contextually relevant responses to user inquiries. For example, if a user asks for a shopping list, the LLM might use long-term memory to recall frequently purchased items and short-term memory to suggest items needed for the current trip. This dynamic use of memory allows the LLM to adapt to user needs, providing timely and personalized assistance.

FIG. 2C illustrates a method that may be performed by components such as the Gen AI phone A 210A, which includes a large language model (LLM) capable of interacting with other mobile devices. At block 210C of method 200C, the method involves detecting, by a large language model (LLM) in a first mobile device, an intention of a second mobile device by analyzing communication signals received from the second mobile device. In some embodiments, this block involves the LLM interpreting signals to understand the intent behind a request from another device. For example, the signals might represent data such as a request for location sharing, a calendar synchronization request, or a data transfer request. The LLM in the first mobile device analyzes the context, content, and metadata of these signals to determine the underlying intention. For example, if the second mobile device sends a signal containing location coordinates and a timestamp, the LLM might interpret this as a request to share real-time location data for a collaborative navigation task.

At block 220C, the method includes facilitating collaboration between the first mobile device and the second mobile device based on the detected intention. The LLM in the first mobile device may make the determination whether to facilitate the collaboration based at least in part on historical data in long-term memory and the contents of short-term memory. In some embodiments, this involves the LLM evaluating past interactions and current context to decide the appropriateness of the collaboration. For example, if the historical data indicates successful past collaborations with the second mobile device for similar tasks, the LLM may decide to facilitate the current request. Conversely, if the historical data or current context suggests potential privacy concerns or conflicts, the LLM may decide not to facilitate the collaboration.

In some embodiments, following the detection of collaboration intentions and the facilitation of interactions between mobile devices, the LLM undergoes a training process using information related to these collaborations. In some embodiments, the LLM engages in unsupervised training to identify patterns related to these interactions. This training method allows the LLM to autonomously analyze collaboration data without predefined labels, discovering new patterns and correlations. By examining communication signals, data exchange frequencies, and contextual metadata, the LLM can identify recurring collaboration scenarios and optimize its responses. This unsupervised approach enhances the LLM's adaptability, enabling it to refine its algorithms and improve the efficiency and relevance of future device-to-device interactions. This continuous learning approach ensures that the LLM adapts to evolving user behaviors and device interactions, thereby enhancing the overall performance and reliability of the system.

At block 230C, the method involves determining whether to store information related to the collaboration in short-term memory or long-term memory. This decision may be influenced by several criteria, including the frequency of the collaboration, its relevance to ongoing tasks, and the potential for future use. In some embodiments, the LLM evaluates the nature of the collaboration to decide the appropriate memory storage. For example, if the collaboration is a one-time event or involves transient data, such as a temporary file transfer, the information may be stored in short-term memory. Conversely, if the collaboration is part of a recurring task or involves critical data, such as shared project files or frequently accessed contact information, it may be stored in long-term memory.

Additional criteria for determining memory storage may include the importance of the collaboration to the user's workflow, the sensitivity of the data involved, and user preferences. For instance, collaborations that significantly impact the user's productivity or involve sensitive information might be prioritized for long-term storage to ensure easy retrieval and enhanced security. Furthermore, user-defined settings or historical patterns of data access can guide the LLM in making these storage decisions, optimizing memory management and enhancing the overall user experience.

At block 240C, the method includes utilizing the information stored in short-term memory and long-term memory to enhance future interactions and collaborations between mobile devices. In some embodiments, this involves the LLM using past collaboration data to improve the efficiency and relevance of future device-to-device interactions. For example, the LLM might suggest optimized data-sharing protocols or recall previous successful communication strategies to guide current tasks.

In the context of FIG. 2A, consider a scenario where Gen AI phone A 210A has previously collaborated with another mobile device to share location data for navigation purposes. The LLM in phone 210A accesses long-term memory to retrieve information about the protocols and security measures that were effective in past collaborations. Simultaneously, it uses short-term memory to incorporate recent data, such as the current location and connectivity status of the devices involved.

By combining insights from both memory types, the LLM can provide a seamless and secure collaboration experience. For instance, it might automatically establish a secure connection using previously successful encryption methods and adjust data transmission rates based on current network conditions. This dynamic use of memory allows the LLM to adapt to the evolving context of device interactions, offering efficient and reliable solutions that enhance the overall performance of mobile device collaborations.

While for purposes of simplicity of explanation, the respective processes are shown and described as a series of blocks in FIGS. 2B and 2C, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

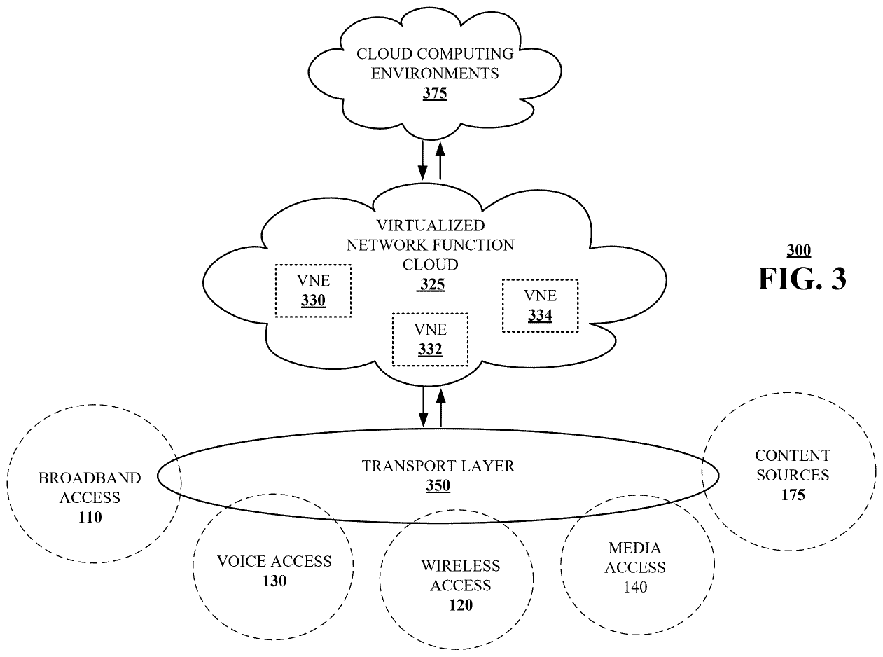

Referring now to FIG. 3, a block diagram 300 is shown illustrating an example, non-limiting embodiment of a virtualized communication network in accordance with various aspects described herein. In particular a virtualized communication network is presented that can be used to implement some or all of the systems, subsystems, and functions described herein. For example, virtualized communication network 300 can facilitate in whole or in part the integration of personalized user interactions, adaptive memory management, and intention recognition capabilities as described herein. This network architecture supports the deployment of large language models (LLMs) across various network components, enabling seamless collaboration between devices and efficient data processing. By leveraging cloud-based resources and edge computing, the virtualized communication network enhances the performance and responsiveness of mobile devices, ensuring a more personalized and intelligent user experience.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements - which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers - each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

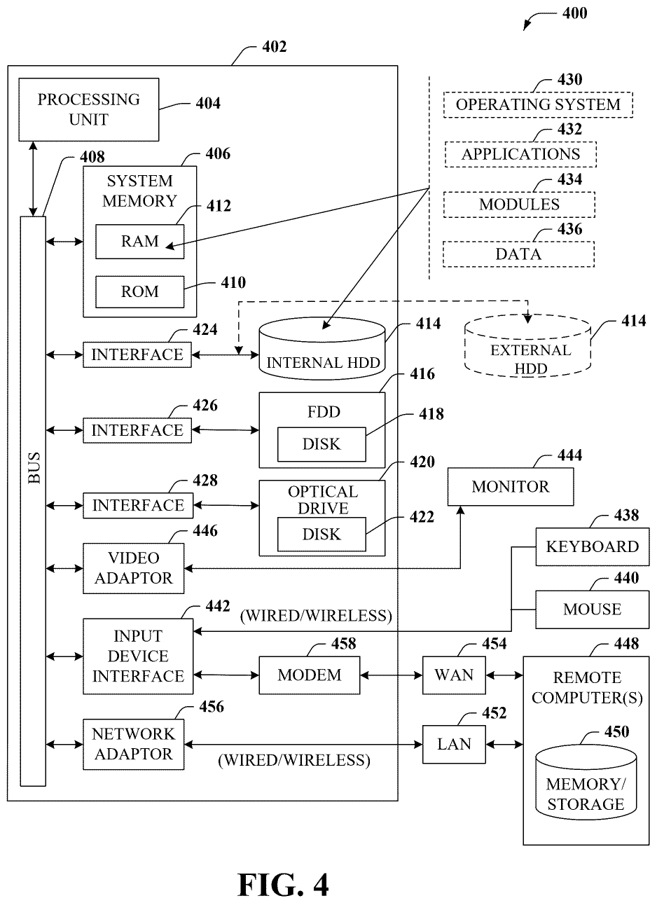

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part the processing of sensor data, training of large language models (LLMs), and management of short-term and long-term memory as described herein. This environment supports the execution of complex operations that enable personalized user interactions, adaptive decision-making, and efficient data management. By providing the necessary computational resources and infrastructure, the computing environment enhances the capabilities of mobile devices to deliver a more tailored and responsive user experience.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

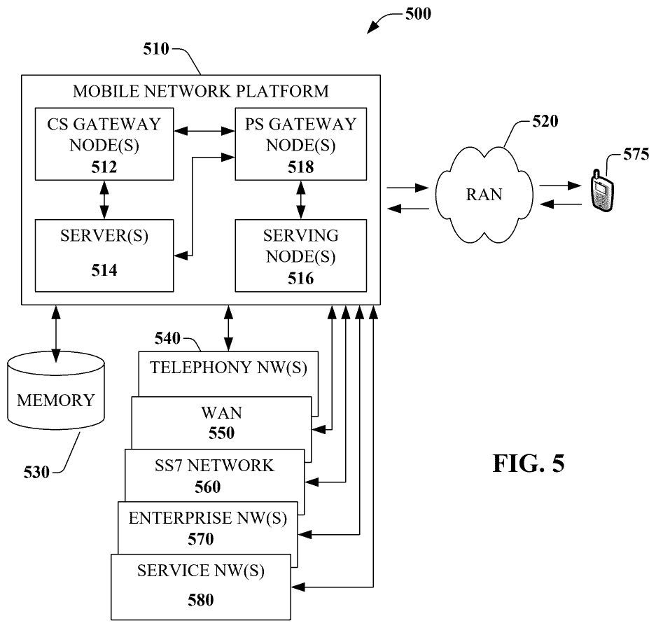

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part the integration of adaptive AI service levels, enhanced AI support from the cloud edge, and multi-modal decision-making capabilities as described herein. This mobile network platform supports both packet-switched and circuit-switched traffic, enabling efficient data processing and communication. By leveraging components such as CS gateway nodes, PS gateway nodes, and serving nodes, platform 510 enhances the ability of mobile devices to provide personalized and intelligent user experiences, ensuring seamless connectivity and optimized resource utilization.

In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format ...) such flows. Such application(s) can comprise add-on features to standard services (for example, provisioning, billing, customer support ...) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

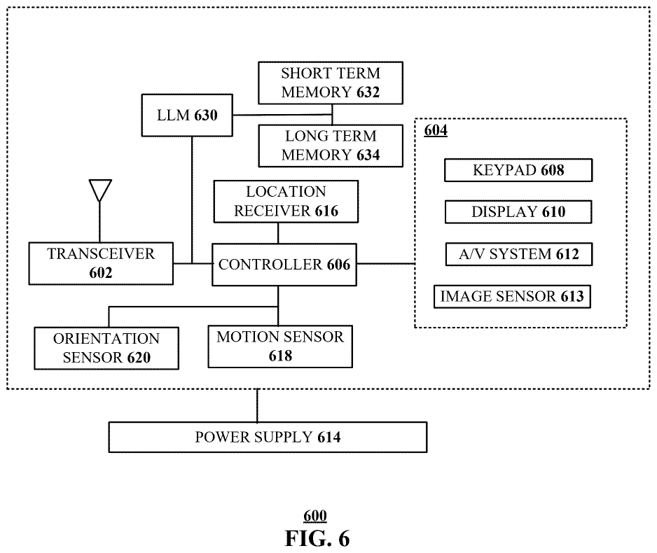

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part the processing of sensor data, training and utilization of a large language model (LLM), and management of short-term and long-term memory as described herein. This device includes components such as a transceiver 602 for communication, a user interface 604 for interaction, and various sensors such as a motion sensor 618 and an orientation sensor 620 to gather data. The LLM 630 processes this data to provide personalized user interactions and decision-making capabilities. The device's controller 606 manages these operations, ensuring efficient data processing and enhancing the overall user experience by providing contextually relevant responses to user queries.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth® , ZigBee® , Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

The implementation of short-term memory 632 and long-term memory 634 in mobile devices involves distinct strategies for data storage and management, tailored to the nature and duration of the information being stored. Short-term memory is designed for temporary storage, often used for immediate tasks and transient data. For example, a mobile device might store a shopping list in short-term memory for the duration of a shopping trip. Once the trip is completed, this data may be overwritten to make space for new information. In some embodiments, short-term memory is periodically cleared, such as at the end of each day, to ensure that only the most relevant and recent data is retained.

In contrast, long-term memory 634 is intended for storing information over extended periods, allowing the device to retain recurring patterns or frequently accessed data. For instance, a user's preferred travel routes or regularly purchased grocery items might be stored in long-term memory. This enables the device to anticipate user needs and provide relevant suggestions without requiring repeated input. The contents of long-term memory are kept longer than those in short-term memory, ensuring that valuable information is preserved for future use.

In some embodiments, the system may transfer contents from short-term memory to long-term memory based on certain criteria, such as the frequency of access or relevance to ongoing tasks. For example, if a user frequently visits the same store and updates their shopping list, the device might transfer this list to long-term memory to streamline future shopping experiences. This dynamic management of memory resources enhances the device's ability to adapt to user habits and preferences, providing a more personalized and efficient user experience.

In FIG. 6, the communication device 600 is equipped with both short-term memory 632 and long-term memory 634, which can be implemented using various technologies depending on the specific requirements for speed, capacity, and durability. In some embodiments, both types of memory may be implemented using the same technology, such as Static RAM (SRAM) or Dynamic RAM (DRAM). SRAM is known for its fast access times and low latency, making it suitable for tasks that require quick data retrieval and processing. DRAM, on the other hand, offers a balance between speed and cost, making it a common choice for temporary data storage in mobile devices.

Alternatively, short-term memory and long-term memory may be implemented using different technologies to optimize their respective functions. For instance, short-term memory could be implemented using SRAM due to its rapid access capabilities, which are ideal for handling immediate tasks and transient data. Long-term memory, in contrast, might be implemented using Flash memory, which is non-volatile and capable of retaining data even when the device is powered off. This makes Flash memory suitable for storing user preferences, frequently accessed data, and system files over extended periods.

Another example of differing technologies for memory implementation involves using DRAM for short-term memory and Solid-State Drives (SSDs) for long-term memory. DRAM's ability to quickly read and write data makes it effective for short-term tasks, while SSDs provide faster read and write speeds compared to traditional hard drives, making them ideal for long-term storage needs. This combination allows the device to efficiently manage data, ensuring that short-term memory is available for immediate processing tasks while long-term memory retains valuable information for future use. By leveraging these different technologies, the communication device 600 can provide a more personalized and efficient user experience, adapting to user habits and preferences.

Various types of artificial intelligence (AI) models can be employed to enhance the functionality and user experience of the communication device 600. Large Language Models (LLMs), such as those used for natural language processing and understanding, are one type of AI model that can be integrated into the device. These models are particularly effective for tasks involving language comprehension, user interaction, and decision-making based on complex linguistic inputs. LLMs can process and analyze vast amounts of text data, enabling the device to provide personalized responses and recommendations to user queries.

In addition to LLMs, non-LLM AI models can also be utilized to address specific tasks that may not require extensive language processing capabilities. For example, Convolutional Neural Networks (CNNs) can be employed for image recognition and processing tasks, leveraging the device's image sensor 613 to analyze visual data and provide contextually relevant information. Similarly, Recurrent Neural Networks (RNNs) or Long Short-Term Memory (LSTM) networks can be used for time-series data analysis, such as predicting user behavior patterns based on historical data collected from the device's sensors.

In some embodiments, combinations of LLMs and non-LLM models may be used to create a more comprehensive AI system within the device. For example, an LLM could be paired with a CNN to enable the device to understand and respond to both verbal and visual inputs, enhancing its ability to interact with users in a multi-modal manner. Additionally, integrating LSTM networks with LLMs could improve the device's ability to predict and adapt to user needs over time, providing a more seamless and intuitive user experience. By leveraging a diverse array of AI models, the communication device 600 can offer a robust and versatile platform capable of addressing a wide range of user requirements and preferences.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x) =confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
receiving sensor data from a plurality of sensors associated with the device;
training a large language model (LLM) using the sensor data to determine at least one pattern;
determining whether to store information related to the at least one pattern in short-term memory or long-term memory; and
utilizing, by the LLM, the information stored in the short-term memory and long-term memory as context when responding to user queries.

2. The device of claim 1, wherein the plurality of sensors includes at least one of a motion sensor, a location sensor, an orientation sensor, or an audio sensor.

3. The device of claim 1, wherein the training of the LLM is performed continuously as new sensor data is received.

4. The device of claim 1, wherein the determining whether to store the information in the short-term memory or the long-term memory is based on a frequency of access.

5. The device of claim 1, wherein the short-term memory is configured to store information for a predetermined period before being overwritten.

6. The device of claim 1, wherein the short-term memory is configured to store information for a predetermined period before being deleted or transferred to long-term memory.

7. The device of claim 1, wherein the determining of whether to store the information in the short-term memory or the long-term memory is based on a user behavior.

8. The device of claim 1, wherein the determining of whether to store the information in the short-term memory or the long-term memory is based on patterns of usage frequency.

9. The device of claim 1, wherein the determining of whether to store the information in the short-term memory or the long-term memory is based on relevance to ongoing tasks.

10. A non-transitory machine-readable medium, comprising executable instructions that, when executed by a processing system including a processor, facilitate performance of operations, the operations comprising:
detecting, by a large language model (LLM) in a first mobile device, an intention of a second mobile device by analyzing communication signals received from the second mobile device;
facilitating collaboration between the first mobile device and the second mobile device based on the detecting the intention;
determining whether to store information related to the collaboration in short-term memory or long-term memory; and
utilizing the information stored in the short-term memory and the long-term memory to enhance future interactions and collaborations.

11. The non-transitory machine-readable medium of claim 10, the operations further comprising training the LLM using the information related to the collaboration.

12. The non-transitory machine-readable medium of claim 10, the operations further comprising performing unsupervised training the LLM to determine at least one pattern related to the collaboration.

13. The non-transitory machine-readable medium of claim 10, wherein the utilizing the information stored in the short-term memory and the long-term memory comprises determining whether to facilitate additional collaborations between mobile devices.

14. The non-transitory machine-readable medium of claim 10, wherein the detecting the intention comprises determining whether the second mobile device is requesting emergency communications.

15. A method, comprising:
receiving, by a processing system including a processor, sensor data from a plurality of sensors;
training, by the processing system, a large language model (LLM) in a mobile device using the sensor data to determine at least one pattern;
determining, by the processing system, whether to store information related to the at least one pattern in short-term memory or long-term memory based on a type of pattern determined; and
utilizing, by the processing system, the information stored in the short-term memory and long-term memory as context when the LLM is responding to user queries.

16. The method of claim 15, wherein the plurality of sensors includes at least one of a motion sensor, a location sensor, an orientation sensor, or an audio sensor.

17. The method of claim 15, wherein the training of the LLM is performed continuously as new sensor data is received.

18. The method of claim 15, wherein the determining whether to store the information in the short-term memory or the long-term memory is based on a frequency of access.

19. The method of claim 15, wherein the short-term memory is configured to store information for a predetermined period before being overwritten.

20. The method of claim 15, wherein the short-term memory is configured to store information for a predetermined period before being deleted or transferred to long-term memory.
